(19) United States
(12) Patent Application Publication
(10) Pub. No.: US 2010/0136343 A1
(43) Pub. Date: Jun. 3, 2010

(54) Composition Including Carbon Nanotubes and Transparent and Conductive Film

(75) Inventors: Youngkyu CHANG, Uiwang-si (KR); Young Sil LEE, Uiwang-si (KR); Young Jun LEE, Uiwang-si (KR); Young Hee LEE, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/463,531

(22) Filed: May 11, 2009

Related U.S. Application Data
(63) Continuation-in-part of application No. PCT/KR2006/005899, filed on Dec. 29, 2006.

(30) Foreign Application Priority Data
Nov. 9, 2006 (KR) 10-2006-0110293

(51) Int. Cl. H01B 1/12; H01B 1/04; B32B 27/08

(52) U.S. Cl. 428/412; 252/511; 428/704; 428/500; 428/426; 977/742; 977/750; 977/752

(57) ABSTRACT

Disclosed are a composite composition comprising carbon nanotubes and a transparent conductive film using the composite composition. The composite composition comprises a solution of an ion conductive polymeric binder in a solvent and carbon nanotubes dispersed in the solution. The transparent conductive film is formed by coating a dispersion of carbon nanotubes in an ion conductive polymeric binder on a base film to allow the transparent conductive film to be electrically conductive as a whole. The composite composition can be used to form a transparent conductive film with excellent bending properties as well as high electrical conductivity and high transparency. Therefore, the composite composition can be applied to transparent electrodes for use in foldable flat panel displays.

### CROSS-REFERENCE TO RELATED APPLICATIONS

This non-provisional application is a continuation-in-part application of PCT Application No. PCT/KR2006/005899, filed Dec. 29, 2006, pending, which designates the U.S. and which is hereby incorporated by reference in its entirety, and claims priority therefrom under 35 USC Section 120. This application also claims priority under 35 USC Section 119 from Korean Patent Application No. 10-2006-0110293, filed Nov. 9, 2006, the entire disclosure of which is also hereby incorporated by reference.

### FIELD OF THE INVENTION

The present invention relates to a composite composition comprising carbon nanotubes and a transparent and conductive film formed using the composite composition.

### BACKGROUND OF THE INVENTION

Electrically conductive and transparent films are widely used in a variety of advanced display devices, including flat panel displays and touch screen panels.

Transparent electrodes for use in flat panel displays have been produced by coating a metal oxide electrode, e.g., an indium-tin oxide (ITO) or indium-zinc oxide (IZO) electrode, on a glass or plastic substrate by deposition, e.g., sputtering.

Such transparent electrode films produced using metal oxide electrodes are highly conductive and transparent, but they have a low frictional resistance and can be cracked easily when bent.

Further, indium, a major material for metal oxide electrodes, is very expensive and is processed by a very complicated processing method.

Under such circumstances, transparent electrodes using conductive polymers, such as polyaniline and polythiophene, are currently being developed because of their ease of processing and excellent bending properties.

These transparent electrode films using conductive polymers can attain high conductivity by doping, and have the advantages of high adhesiveness of coating films to substrates and excellent bending properties.

However, it can be difficult for transparent films using conductive polymers to attain an electrical conductivity sufficient for use in transparent electrodes and transparent films using conductive polymers also suffer from the problem of low transparency.

### SUMMARY OF THE INVENTION

The present invention has been made to solve the foregoing problems of the prior art and provides a composite composition comprising carbon nanotubes that can be used to form a transparent conductive film with excellent bending properties as well as high electrical conductivity and high transparency, and thus can be used in transparent electrodes for use in foldable flat panel displays.

According to a first embodiment of the present invention, there is provided a composite composition comprising a solution of an ion conductive polymeric binder in a solvent and carbon nanotubes dispersed in the solution.

The present invention also provides a transparent conductive film formed using the composite composition. According to a second embodiment of the present invention, the transparent conductive film can be formed by coating a dispersion of carbon nanotubes in an ion conductive polymeric binder on a base film to provide a transparent electrically conductive film.

The transparent conductive film formed using the composite composition according to the second embodiment of the present invention can be used in transparent electrodes for use in foldable flat panel displays.

### DESCRIPTION OF DRAWINGS

The above and other features and advantages of the present invention will be more clearly understood from the following detailed description taken in conjunction with the accompanying drawing, in which:

FIG. 1 is a graph showing test results for the surface resistance and transparency of transparent conductive films formed in Examples 1 through 7 of the present invention.

### DETAILED DESCRIPTION OF INVENTION

In a first embodiment, the present invention provides a composite composition comprising a solution of an ion conductive polymeric binder in a solvent and carbon nanotubes dispersed in the solution.

According to a second embodiment of the present invention, the present invention provides a transparent conductive film formed by coating a dispersion of carbon nanotubes in an ion conductive polymeric binder on a base film to form a transparent electrically conductive film.

Specific details of other embodiments are included in the following description and accompanying drawing.

The advantages and features of the present invention and methods for achieving them will become more apparent from the following embodiments that are described in detail below. However, the present invention is not limited to the illustrated embodiments and may be embodied in various different forms. Rather, the disclosed embodiments are provided so that the disclosure of the present invention will be thorough and complete, and will fully convey the scope of the invention to those skilled in the art to which the present invention pertains. The scope of the present invention is defined by the claims that follow. The same elements or parts are denoted by the same reference numerals through the specification.

As used herein, the expression that a certain layer or film is on another layer or film means that the certain layer or film may be present directly on the another layer or film, or a third (or more) layer or film may be interposed therebetween.

Carbon nanotubes are very long and have very low electrical resistance values in view of their inherent structural characteristics.

Carbon nanotubes are used in various applications. Particularly, extensive research on carbon nanotubes as electrode materials due to their high electrical conductivity is actively underway.

When carbon nanotubes are applied to a glass or polymer film to produce an electrode, the adhesiveness between the individual carbon nanotubes is reduced, resulting in decreased electrical conductivity of the electrode and damage to the electrode.

In view of the foregoing, the present invention is intended to provide a composite composition comprising carbon nanotubes that utilizes high electrical conductivity of the carbon nanotubes, maintains high adhesiveness between the individual carbon nanotubes, is easy to coat on a base film (e.g., a polymer or glass film), and has high adhesiveness between the base film and a coating film formed after coating of the composite composition.

First, the composite composition according to the first embodiment of the present invention comprises carbon nanotubes, a polymeric binder, and a solvent.

The carbon nanotubes are coated in one or more layers on one film to increase the conductivity of the entire film.

The carbon nanotubes used in the present invention can include single-walled carbon nanotubes, double-walled carbon nanotubes, and combinations thereof. The composite composition of the present invention can include the carbon nanotubes in an amount of at least about 90% by weight or more, with the remainder or balance of the composition comprising the other components (solvent(s) and binder resin) as discussed herein.

The carbon nanotubes used in the present invention can have an outer diameter of about 1 to about 4 nm and a length of about 10 to about 1,000 nm. The carbon nanotubes can be purified by an acid treatment.

The solvent may be selected from water, alcohols, or a combination thereof. Suitable alcohols include those having one to six carbon atoms. Exemplary alcohols useful in the invention include alcohols having two or three carbon atoms, such as ethanol and propanol, including isopropanol. A mixed solution of water and isopropyl alcohol may be used taking into consideration the solubility of the polymeric binder. The volume ratio (vol %) of water to isopropyl alcohol in the mixed solution can range from about 20-80:80-20.

The use of water is recommended for environmentally friendly processing and for improving the dispersibility of the polymeric binder.

Generally the composite composition of the invention can include the solvent(s) in an amount sufficient to promote application of the composite composition to a suitable substrate as discussed herein and also to provide a concentration of carbon nanotubes in an amount sufficient to impart the desired electrical conductivity and adhesiveness to the product. In exemplary embodiments of the invention, the amount of solvent(s) in the composite composition (for example water and isopropyl alcohol) can range from about 5 to about 100 mg, and the carbon nanotubes can be present in an amount of about 100 ml.

The polymeric binder is used to increase the adhesiveness of a coating film formed after coating of the carbon nanotubes. Any known polymeric binder that can be dissolved in a solvent, such as alcohol, may be used in the present invention.

An ion conductive or ion exchange resin may be used as the polymeric binder. However, if the ion conductive resin is a hydrophilic and moisture-sensitive resin, several problems, e.g., weak adhesiveness, after processing may result.

Thus the polymeric binder used in the present invention can be an ion conductive or ion exchange resin composed of hydrophobic atoms only.

Specifically, the polymeric binder can be a fluorinated polyethylene, called ‘Nafion’, represented by Formula 1:

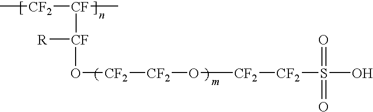

wherein R is C₁-C₈ alkyl or C₁-C₈ fluorinated alkyl, m is an integer from 0 to 3, and n is from 10 to 10,000.

In Formula I, n represents the degree of polymerization and may be optionally varied.

That is, the polymeric binder contains fluorine atoms and has sulfonyl groups introduced thereto.

Alternatively, the polymeric binder may be a thermoplastic polymer into which one or more carboxyl, sulfonyl, phosphonyl or sulfonimide groups, or a combination thereof, are introduced. Exemplary thermoplastic polymers that can be used as the polymeric binder include without limitation polyester, polyethersulfone, polyetherketone, polyurethane, polyphosphagen and the like and combinations thereof that has an alkyl or allyl moiety as a main chain in each polymer. To prevent the absorption of moisture, fluoro groups may be introduced into each polymer.

The polymeric binder can be dissolved in a polar solvent.

The composite composition of the present invention may be coated in the form of a solution or slurry on a base film as a substrate.

Any known polymer film or glass thin film may be used as the base film. Specific examples of suitable materials for the base film include but are not limited to polyethylene terephthalate (PET), polyethylene naphthalate (PEN), and polyethersulfone (PES).

Any film that has a transparency of about 90% or more in the visible region and whose surface is treated may be used in the present invention.

A glass plate may also be used as the base film. Glass plates are currently in use in flat panel displays.

The composite composition according to the first embodiment of the present invention can be used to produce a transparent electrode for use in a flat panel display in accordance with the following procedure.

First, carbon nanotubes can be treated with an acid or purified and dispersed in water and/or a solvent. The final dispersion of the carbon nanotubes can be achieved using an ultrasonic disperser.

Thereafter, the solution of the carbon nanotubes can be mixed with an alcohol solution of an ion conductive polymer. The mixed solution can be sufficiently stirred using an agitator. The resulting solution can be applied to a glass or PET plate by a suitable technique, such as spray coating, impregnation or electrospinning.

It is important to substantially disperse the carbon nanotubes in the solution of the ion conductive polymeric binder (e.g., an alcohol containing solution of the ion conductive polymeric binder). To this end, in the present invention, carbon nanotubes can be dispersed in water and/or a solvent, an ion conductive polymeric binder can be added to the solution, and an ultrasonic disperser can be used to enhance the dispersion effects of the carbon nanotubes.

Finally, the dispersion can be centrifuged to remove an undispersed portion of the solution before use.

As used herein, reference to nanotubes that are substantially dispersed in the solution of the ion conductive polymeric binder means that at least about 90% or more of the carbon nanotubes can be dispersed in the ion conductive polymer. In contrast, only about 50% of the carbon nanotubes are dispersed in a general dispersant, e.g., low-molecular weight sodium dodecylsulfate (SDS), or a general water-soluble polymer.

The application frequency of the solution can affect the transparency, and the conductivity of the final transparent electrode. Frequent application of the composite composition can be advantageous in terms of conductivity, but can also cause the disadvantage of low transparency.

Therefore, it can be important to control the concentration of the solution or to determine the application frequency of the solution so as to maintain the transparency of the transparent electrode at about 80% or more and to achieve maximum conductivity.

In exemplary embodiments of the invention, the film thickness can range from about 50 nm to about 5 μm, for example about 100 nm or less. Films with a thickness of about 100 nm or less can advantageously exhibit a transparency of about 80% or more. The present invention is not so limited, however, and as discussed herein, the present invention also provides the benefit of improved adhesiveness for varying film thicknesses, even for films with a thickness of 100 nm or more.

Hereinafter, the composite composition and the transparent conductive film using the composite composition according to the embodiments of the present invention will be explained with reference to the following specific examples and comparative examples. These examples are provided to illustrate that a transparent electrode produced using the transparent conductive film exhibits high transparency, high electrical conductivity and excellent adhesiveness. Disclosures that are not included herein will be readily recognized and appreciated by those skilled in the art, and thus their description is omitted.

### EXAMPLES

### 1. Preparation of Samples

Single-walled carbon nanotubes (purity: 60-70%, SAP, ILJIN Nanotech Co., Ltd., Korea) prepared by arc discharge are used in the following examples and comparative examples. The carbon nanotubes have a length of about 20 μm and a thickness of about 1.4 nm.

A solution of 5 wt % of Nafion (DE 520, DuPont) as a polymeric binder in isopropyl alcohol and water is prepared.

A PET film (Skyrol SH34, SK chemical, Korea) is used as a base film.

### 2. Measurement of Electrical Conductivity

The conductivity of a film for a transparent electrode is measured by coating four upper edges of the film with gold to produce an electrode and measuring the surface resistance of the electrode by a four-probe technique, and the obtained values are expressed in Q/sq.

### 3. Measurement of Transparency

Given that the transparency of the base film or glass is 100, the transparency of a film is measured at a wavelength of 550 nm using a UV/vis spectrophotometer.

### 4. Adhesiveness

The adhesiveness of a film overlying the PET film is evaluated by attaching a cellophane tape on the film overlying the PET film for a predetermined time period, peeling the cellophane tape, and observing whether or not the polymeric binder or the carbon nanotubes remained on the cellophane tape. When the polymeric binder or the carbon nanotubes remain over the entire surface of the cellophane tape, the adhesiveness of the film is judged to be ‘X’. When a portion of the polymeric binder or the carbon nanotubes remain on the surface of the cellophane tape, the adhesiveness of the film is judged to be ‘Δ’. When no residue is visually observed on the surface of the cellophane tape, the adhesiveness of the film is judged to be ‘◯’.

### 5. Examples and Comparative Examples

### Examples 1 to 7

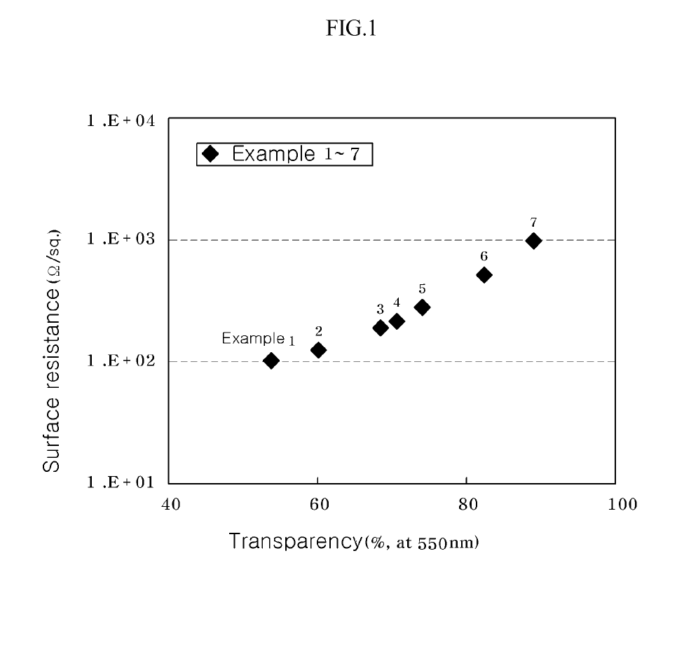

The single-walled carbon nanotubes (CNTs) are dispersed in a mixed solution of water and isopropyl alcohol (40:60 (v/v)), and then the dispersion is mixed with Nafion as the ion conductive polymer in a ratio of 1:1. The mixed solution is dispersed by ultrasonic dispersion. The resulting solution is applied to each of the PET films by spray coating. At this time, the application frequency of the solution is varied to form coating films (Examples 1 to 7) having various thicknesses. The coating films are tested for conductivity, transparency, and adhesiveness. The results are shown in Table 1 and FIG. 1.

### Comparative Example 1

The single-walled CNTs are dispersed in dichloroethane by ultrasonic dispersion. The resulting solution is applied to the PET film by spray coating. The coating film is tested for conductivity, transparency, and adhesiveness. The results are shown in Table 2.

### Comparative Example 2

A coating film is formed in the same manner as in Comparative Example 1, except that thin multiwalled CNTs are used instead of the single-walled CNTs. The coating film is tested for conductivity, transparency, and adhesiveness. The results are shown in Table 2.

### Comparative Example 3

The surface of the single-walled CNTs is functionalized using a mixed solution of sulfuric acid and nitric acid. After the functionalized CNTs are dispersed in dichloroethane, the resulting solution is applied to the PET film by spray coating. The coating film is tested for conductivity, transparency, and adhesiveness. The results are shown in Table 2.

### Comparative Example 4

After the single-walled CNTs are dispersed in dichloroethane, the dispersion is mixed with poly(3,4-ethylenedioxythiophene (PEDOT) as an conductive polymer in a predetermined ratio. The carbon nanotubes are dispersed using an ultrasonic disperser. The resulting solution in which the carbon nanotubes are dispersed is applied to the PET film by spray coating. The coating film is tested for conductivity, transparency, and adhesiveness. The results are shown in Table 2.

### Comparative Example 5

The single-walled CNTs are dispersed in water and sodium dodecylsulfate (SDS) as a surfactant, and then the solution is homogeneously dispersed by ultrasonic dispersion. The homogeneous solution is applied to the PET film by spray coating. The coating film is tested for conductivity, transparency, and adhesiveness. The results are shown in Table 2.

### Comparative Example 6

The PET film is dipped 100 times in a dispersion of the single-walled CNTs in dichloroethane. The resulting solution is applied to the PET film by spray coating. The coating film is tested for conductivity, transparency, and adhesiveness. The results are shown in Table 2.

### Comparative Example 7

The single-walled CNTs are dispersed in dichloroethane and then the dispersion is applied to the PET film, into which amine groups are introduced, to form a coating film. The coating film is tested for conductivity, transparency, and adhesiveness. The results are shown in Table 2.

### 6. Analysis of Results

TABLE 1

| | Example No. | | | | | | |
|---|---|---|---|---|---|---|---|
| | 1 | 2 | 3 | 4 | 5 | 6 | 7 |
| Components | CNTs/ | CNTs/ | CNTs/ | CNTs/ | CNTs/ | CNTs/ | CNTs/ |
| | Nafion | Nafion | Nafion | Nafion | Nafion | Nafion | Nafion |
| Thickness (nm) | 260 | 192 | 154 | 130 | 110 | 96 | 62 |
| Resistance (Ω/sq.) | 102 | 126 | 189 | 215 | 284 | 524 | 970 |
| Transparency (%) | 54 | 60 | 68.5 | 70.5 | 74 | 82 | 89 |
| Adhesiveness | 0 | 0 | 0 | 0 | 0 | 0 | 0 |

TABLE 2

| | Comparative Example No. | | | | | | |
|---|---|---|---|---|---|---|---|
| | 1 | 2 | 3 | 4 | 5 | 6 | 7 |
| Components | CNTs | TWCNTs | Acid- | CNTs/ | CNTs/ | CNTs | CNTs |
| | | | treated | PEDOT | SDS | | (amino-PET) |
| | | | CNTs | | | | |
| Coating Technique | Spray | Spray | Spray | Spray | Spray | Dipping/ | Spray |
| | | | | | | Spray | |
| Resistance (Ω/sq.) | 800 | 2000 | 10⁵ | 510 | 600 | 350 | 300 |
| Transparency (%) | 70 | 50 | 70 | 76 | 82 | 80 | 80 |
| Adhesiveness | X | X | X | Δ | X | X | X |

As can be seen from the results of Table 1, the coating films of Examples 1 to 7, which were formed by coating a mixture of the carbon nanotubes and the ion conductive polymer on the respective base films, show high adhesiveness to the base films, high electrical conductivity and high transparency.

In contrast, the results of Table 2 demonstrate that the coating films of Comparative Examples 1 to 7 comprising no polymer show relatively high conductivity and high transparency, but have poor adhesion to the respective base films.

Although the foregoing embodiments of the present invention have been described herein with reference to the accompanying drawing and tables, the present invention is not limited to the embodiments and may be embodied in various different forms. Those skilled in the art will appreciate that the present invention may be practiced otherwise than as specifically described without changing the technical spirit or essential features of the present invention. Therefore, it should be understood that the foregoing embodiments are merely illustrative in all aspects and are not to be construed as limiting the present invention.

That which is claimed is:

1. A composite composition comprising a solution of an ion conductive polymeric binder in a solvent and carbon nanotubes dispersed in the solution.

2. The composite composition according to claim 1, wherein the ion conductive polymeric binder is hydrophobic.

3. The composite composition according to claim 1, wherein the ion conductive polymeric binder comprises a fluorinated polyethylene having sulfonyl groups introduced therein, a thermoplastic polymer having an alkyl or allyl moiety as a main chain and having one or more carboxyl, sulfonyl, phosphonyl or sulfonimide groups introduced therein, or a combination thereof.

4. The composite composition according to claim 3, wherein said thermoplastic polymer comprises polyester, polyethersulfone, polyetherketone, polyurethane, polyphosphagen, or a combination thereof.

5. The composite composition according to claim 4, wherein said thermoplastic polymer further comprises one or more fluoro groups.

6. The composite composition according to claim 1, wherein the carbon nanotubes include about 90% by weight or more of single-walled or double-walled carbon nanotubes, and have an outer diameter of about 1 to about 4 nm and a length of about 10 to about 1,000 nm.

7. The composite composition according to claim 1, wherein the solvent comprises water, an alcohol, or a combination thereof.

8. The composite composition according to claim 1, wherein the solvent is a mixed solution of water and isopropyl alcohol.

9. The composite composition according to claim 1, wherein the solvent is a mixed solution of water and isopropyl alcohol in a volume ratio (vol %) of about 20-80:80-20.

10. A transparent conductive film formed by coating a dispersion of carbon nanotubes in an ion conductive polymeric binder on a base film.

11. The transparent conductive film according to claim 10, wherein said film is substantially uniformly electrically conductive.

12. The transparent conductive film according to claim 10, wherein the ion conductive polymeric binder is hydrophobic.

13. The transparent conductive film according to claim 10, wherein the ion conductive polymeric binder comprises a fluorinated polyethylene having sulfonyl groups introduced therein, a thermoplastic polymer having an alkyl or allyl moiety as a main chain and having one or more carboxyl, sulfonyl, phosphonyl or sulfonimide groups introduced therein, or a combination thereof.

14. The transparent conductive film according to claim 13, wherein said thermoplastic polymer comprises polyester, polyethersulfone, polyetherketone, polyurethane, polyphosphagen, or a combination thereof.

15. The transparent conductive film according to claim 14, wherein said thermoplastic polymer further comprises one or more fluoro groups.

16. The transparent conductive film according to claim 10, wherein the carbon nanotubes include about 90% by weight or more of single-walled or double-walled carbon nanotubes.

17. The transparent conductive film according to claim 10, wherein the transparent conductive film has a transparency of about 80% or more and a surface resistance of about 1,000 Ω/sq. or less.

18. The transparent conductive film according to claim 10, wherein the base film comprises a polyester polymer film, a polycarbonate polymer film, a polyethersulfone polymer film, an acrylic polymer film, or a combination thereof.

19. The transparent conductive film according to claim 10, wherein the base film is a glass film.

20. A transparent electrode comprising the transparent conductive film according to claim 10.
